(19) United States
(12) Patent Application Publication
(10) Pub. No.: US 2019/0248464 A1
(43) Pub. Date: Aug. 15, 2019

(54) CONNECTING ASSEMBLY, ARM OF UNMANNED AERIAL VEHICLE, AND UNMANNED AERIAL VEHICLE

(71) Applicant: SZ DJI TECHNOLOGY CO., LTD., Shenzhen (CN)

(72) Inventors: Fangming YE, Shenzhen (CN); Zhao YANG, Shenzhen (CN); Di OU, Shenzhen (CN); Hongshan LI, Shenzhen (CN)

(21) Appl. No.: 16/394,966

(22) Filed: Apr. 25, 2019

Related U.S. Application Data
(63) Continuation of application No. PCT/CN2016/103649, filed on Oct. 27, 2016.

(51) Int. Cl. B64C 1/06; B64C 39/02

(52) U.S. Cl. CPC B64C 1/063; B64C 39/024; B64C 2201/024; B64C 2201/102; B64C 2201/108; B64C 2201/126; B64C 2201/042

(57) ABSTRACT

An unmanned aerial vehicle includes a fuselage and an arm coupled to the fuselage. The arm includes a first segment, a second segment, and a connecting assembly coupling and locking the first segment and the second segment to each other. The connecting assembly includes a first connecting member and a second connecting member. The first connecting member is rotatably coupled to one of the first segment or the second segment. The second connecting member is coupled to another one of the first segment or the second segment. The first connecting member is rotatable relative to the arm and engages with the second connecting member to lock the first segment and the second segment.

### CROSS-REFERENCE TO RELATED APPLICATION

This application is a continuation application of International Application No. PCT/CN2016/103649, filed on Oct. 27, 2016, the entire contents of which are incorporated herein by reference.

### TECHNICAL FIELD

The present disclosure relates to the field of aerial vehicle and, more particularly, to a connecting assembly, an arm of an unmanned aerial vehicle including the connecting assembly, and an unmanned aerial vehicle.

### BACKGROUND

Presently, unmanned aerial vehicles (UAVs) are used in aerial photography, surveillance, exploration, rescue, agricultural plant protection and other fields. For users, UAVs need to realize multi-functions during operation. In addition, how to conveniently and quickly store and transport a UAV when the UAV is not in operation has become an issue to be addressed.

### SUMMARY

In accordance with the disclosure, there is provided an unmanned aerial vehicle including a fuselage and an arm coupled to the fuselage. The arm includes a first segment, a second segment, and a connecting assembly coupling and locking the first segment and the second segment to each other. The connecting assembly includes a first connecting member and a second connecting member. The first connecting member is rotatably coupled to one of the first segment or the second segment. The second connecting member is coupled to another one of the first segment or the second segment. The first connecting member is rotatable relative to the arm and engages with the second connecting member to lock the first segment and the second segment.

### BRIEF DESCRIPTION OF THE DRAWINGS

FIG. 1 is a perspective view of an unmanned aerial vehicle (UAV) consistent with disclosed embodiments of the present disclosure.

FIG. 2 is another perspective view of the UAV in FIG. 1 at another status consistent with disclosed embodiments of the present disclosure.

FIG. 3 is an enlarged view of a portion III of the UAV in FIG. 2 consistent with disclosed embodiments of the present disclosure.

FIG. 4 is a perspective view of a partial structure of the UAV in FIG. 1, showing a branch-arm and a connecting assembly, consistent with disclosed embodiments of the present disclosure.

Reference numerals used in the drawings include: 100, unmanned aerial vehicle (UAV); 10, fuselage; 20, arm; 21, main arm; 22, branch-arm; 221, installation member; 222, first segment; 2221, first recess portion; 2222, support protrusion portion; 223, second segment; 2231, bottom surface; 2232, side surface; 2233, accommodating groove; 223a, second recess portion; 224, rotating shaft; 225, set screw; 30, connecting assembly; 31, first connecting member; 311, rotating portion; 3111, matching surface; 3112, side surface; 3113, holding groove; 3114, ear portion; 3115, rotating shaft; 3116, recess groove; 3117, rotating shaft; 312, first engaging member; 3121, engaging end; 3122, driving end; 313 and 314, set screw; 32, second connecting member; 321, second engaging member; 3211, engaging recess; 3212, stopping portion; 3213, guiding portion; 3213a, guiding surface; 322, unlocking portion; 3221, supporting portion; 3222, pressing portion; 3223, driving portion; 40, power assembly; and 50, stand.

### DETAILED DESCRIPTION OF THE EMBODIMENTS

Technical solutions of the present disclosure will be described with reference to the drawings. It will be appreciated that the described embodiments are some rather than all of the embodiments of the present disclosure. Other embodiments conceived by those having ordinary skills in the art on the basis of the described embodiments without inventive efforts should fall within the scope of the present disclosure.

As used herein, when a first component is referred to as “fixed to” a second component, it is intended that the first component may be directly attached to the second component or may be indirectly attached to the second component via another component. When a first component is referred to as “connecting” to a second component, it is intended that the first component may be directly connected to the second component or may be indirectly connected to the second component via a third component between them. The terms “perpendicular,” “horizontal,” “left,” “right,” and similar expressions used herein are merely intended for description.

Unless otherwise defined, all the technical and scientific terms used herein have the same or similar meanings as generally understood by one of ordinary skill in the art. As described herein, the terms used in the specification of the present disclosure are intended to describe exemplary embodiments, instead of limiting the present disclosure. The term “and/or” used herein includes any suitable combination of one or more related items listed.

Further, in the present disclosure, the disclosed embodiments and the features of the disclosed embodiments may be combined when there are no conflicts.

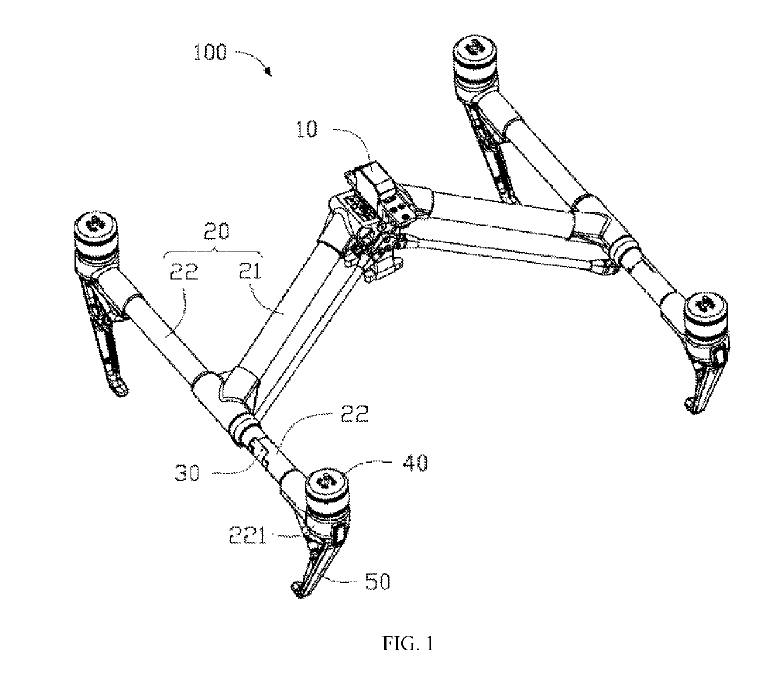

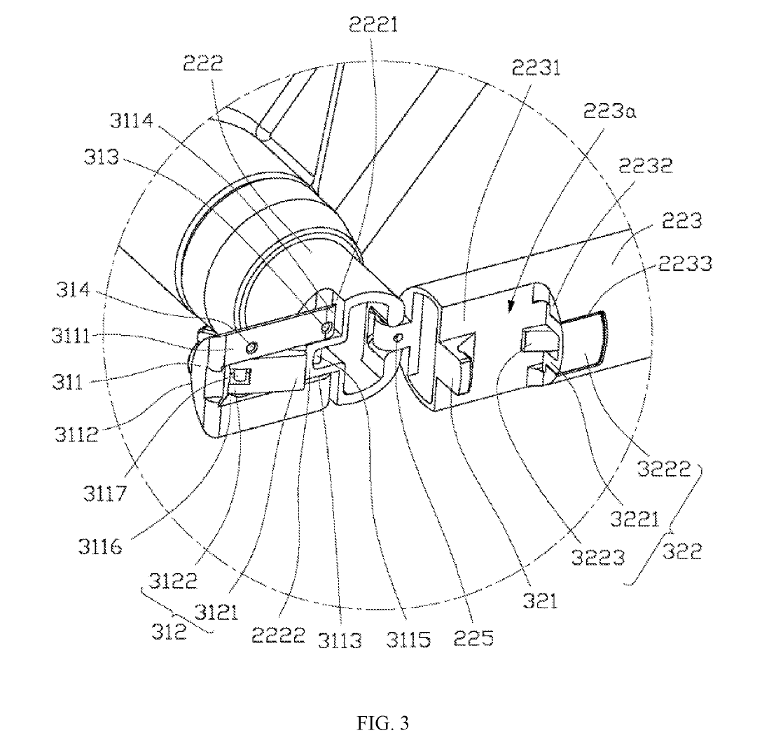

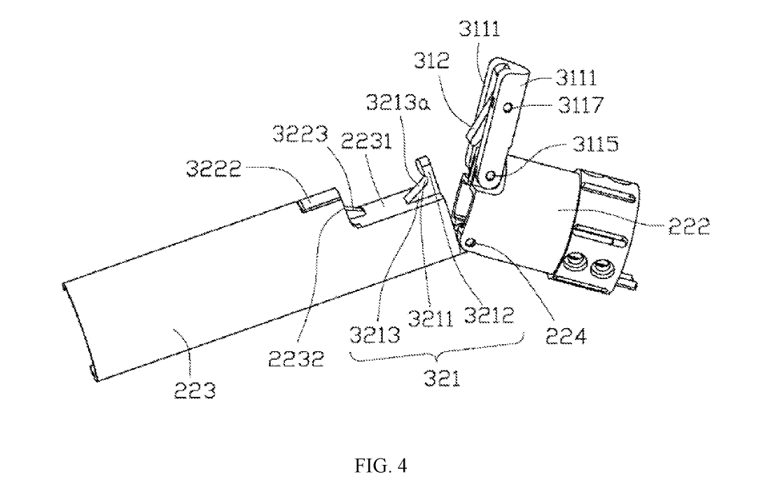

Referring to FIGS. 1 to 4, an unmanned aerial vehicle 100 of the present disclosure includes a fuselage 10, an arm 20, a connecting assembly 30, and a power assembly 40. In some embodiments, the UAV 100 may include a quadrotor UAV. In these embodiments, the power assemblies 40 may include rotor assemblies and the number of the power assemblies may be four. The four power assemblies 40 are distributed in a rectangular region around the fuselage 10 through support of the arms 20. Each of the power assemblies 40 is arranged at one vertex of the rectangle. According to the aerodynamic principle, in order to avoid turbulence of the power assemblies 40 during rotation, adjacent power assemblies 40 may have different rotation directions during operation, and power assemblies 40 at opposite corners may have same directions during operation.

The number of the power assemblies 40 can be changed according to various application scenarios. For example, the number of the power assemblies 40 can be two, three, six, eight, sixteen, etc. In some embodiments, the number of the power assemblies 40 may be only one. Accordingly, the number of the arms 20 may be chosen according to the number of the power assemblies 40.

The fuselage 10 may serve as a load-supporting member of the UAV 100. An electrical installation member may be arranged at or in the fuselage 10. The electrical installation member may carry and support a sensor, a circuit board, a processor, a communication circuit, a battery, and/or other suitable electronic components. In some embodiments, the fuselage 10 may include a frame that is formed by a bracket and arranged at a middle portion of the UAV 100. The arm 20 can be rotatably coupled to a side of the fuselage 10. In some embodiments, an outer housing may be arranged over the fuselage 10 to protect electronic components arranged at or in the fuselage 10. In some embodiments, the outer housing may include a shape that can reduce air resistance during flight. For example, the outer housing may include a streamlined shape, a circular shape, an elliptical shape, and/or the like.

Depending on the field of application of the UAV 100, the fuselage may carry other loads for achieving a certain task. For example, when the UAV 100 is used for aerial photography, the fuselage 10 may carry a photographing device equipped with a stabilizing gimbal. When the UAV 100 is used for spraying a pesticide, the fuselage 10 may carry a pesticide box and a spraying apparatus. When the UAV 100 is used for a competitive game, the fuselage 10 may carry a gaming device or the like.

The arms 20 may be used for supporting the power assemblies 40, such that the power assemblies 40 may be arranged around the fuselage 10 in a preset pattern. The arm 20 can be rotatably coupled to a side of the fuselage 10, and hence the arm 20 can be adjusted to different positions and statuses with respect to the fuselage 10. For example, upon landing, the arm 20 may rotate downward relative to the fuselage 10 to provide support for the UAV 100; and during flight, the arm 20 may rotate upward relative to the fuselage 10, such that the arm 20 is prevented from blocking the load at the fuselage 10. The terms “upward” and “downward” use a normal flight status of the UAV 100 as a reference. The term “downward” refers to a direction from the UAV 100 toward the ground, and the term “upward” refers to a direction from the UAV to a direction away from the ground. However, since statuses of the UAV 100 may vary, the above descriptions do not limit the scope of the present disclosure.

In some embodiments, the arm 20 includes a main arm 21 and a branch-arm 22 coupled to the main arm 21. One end of the main arm 21 can be rotatably coupled to the fuselage 10, and the other end of the main arm 21 is coupled to the branch-arm 22. In some embodiments, the main arm 21 and the branch-arm 22 may be coupled to each other in an approximately “T” shape.

In some embodiments, a relative angle between the main arm 21 and the fuselage 10 may be adjusted by using a screw rod and a nut to match with each other. In addition, the screw rod and the nut may be matched with each other in such a manner that the branch-arm 22 can stay at any angle with respect to the fuselage 10, to facilitate adjusting a shape of the UAV 100 according to different needs.

In some embodiments, the number of the main arms 21 may be two, and the two main arms 21 may be coupled to opposite sides of the fuselage 10, and each of the main arms 21 may be coupled to two branch-arms. The two branch-arms 22 may be coaxially arranged on opposite sides of the main arm 21. In some embodiments, the branch-arms 22 on two sides of the main arm 21 can be integrally connected, and the branch-arms 22 may appear as an integral elongated arm.

The number of the main arms 21 and the number of corresponding branch-arms 22 may vary according to actual needs. For example, the number of the main arms 21 may be three, four, or more.

In some embodiments, the main arm 21 may have a parallel link structure, but the main arm 21 is not limited to the above-described structures. Any suitable structures that can rotatably couple the main arm to the fuselage 10 can be used for the UAV 100, which are not restricted in the present disclosure.

In some embodiments, the branch-arm 22 may include a long rod having approximately a cylindrical shape. An approximately central position of the branch-arm 22 may be coupled to the main arm 21, and the branch-arm 22 may be approximately perpendicular to the main arm 21. Two ends of the branch-arm 22 are provided with installation members 221 for installing the power assemblies 40.

The connection manner between the branch-arm 22 and the main arm 21 is not limited to the illustrated examples. For example, the branch-arm 22 may not be perpendicular to the main arm 21. As another example, an end of the branch-arm 22 may be coupled to the main arm 21, etc.

In some embodiments, the branch-arm 22 may include several segments, such that the branch-arm 22 can be folded to reduce a storage volume when the UAV 100 is not in operation. Structures of segments of the branch-arm 22 are described below in connection with the structure of the connecting assembly 30.

The connecting assembly 30 may be used for coupling two components. The connecting assembly 30 may include a locking function such that the two components can be fixed with respect to each other. Further, the connecting assemblies 30 can be unlocked, such that the two components can move with respect to each other.

In some embodiments, each branch-arm 22 includes a first segment 222 and a second segment 223 that can be coupled to the first segment 222, and the connecting assembly 30 is arranged between the first segment 222 and the second segment 223. The connecting assembly 30 can lock relative connection positions of the first segment 222 and the second segment 223, and further can release the locking between the first segment 222 and the second segment 223, such that the first segment 222 and the second segment 223 can move relative to each other. In some embodiments, the first segment 222 and the second segment 223 are rotatably coupled to each other through a rotating shaft 224. The branch-arm 22 further includes a set screw 225 that can match with the rotating shaft to prevent the rotating shaft from moving relative to the first segment 222 and the second segment 223 in a direction of central axis of the rotating shaft. In some embodiments, the set screw 225 passes through the second segment 223 to match with the rotating shaft.

In some embodiments, the connecting assembly 30 includes a first connecting member 31 and a second connecting member 32. The first connecting member 31 is arranged on the first segment 222, and the second connecting member 32 is arranged on the second segment 223.

The first connecting member 31 can be rotatably coupled to the first segment 222 and can engage with the second connecting member 32 arranged on the second segment 223 to lock the first segment 222 with the second segment 223. The first connecting member 31 includes a rotating portion 311 and a first engaging member 312. The rotating portion 311 can be rotatably coupled to the first segment 222. The first engaging member 312 is arranged at the rotating portion 311 and can engage with the second connecting member 32.

In some embodiments, the rotating portion 311 may have approximately a partial cylindrical shape, and includes a matching surface 3111 and a side surface 3112. The matching surface 3111 and the side surface 3112 are connected to each other to form an outer peripheral surface of the rotating portion 311. In some embodiments, the matching surface 3111 may be a flat surface, and the side surface 3112 may be a partial cylindrical surface. As the first connecting member 31 engages with the second connecting member 32, i.e., the first segment 222 and the second segment 223 are locked to each other, the matching surface 3111 may be in contact with the second segment 223 to match with the second segment 223, such that the locking is relatively stable and reliable. Further, since a shape of the side surface 3112 matches a shape of an outer peripheral surface of the second segment 223, as the first segment 222 and the second segment 223 are locked to each other, the first connecting member 31 and the outer peripheral surface of the second segment 223 may form an integral cylindrical surface, without a structural protrusion. Thus, the UAV 100 may have a compact appearance and a compact structure.

Shapes of the matching surface 3111 and the side surface 3112 can be changed according to the shape of the rotating portion 311, detailed descriptions of which are omitted here.

In some embodiments, a holding groove 3113 is arranged at an end portion of the rotating portion 311 that is coupled to the first segment 222. The rotating portions 311 includes ear portions 3114 on two sides of the holding groove 3113. Correspondingly, the first segment 222 includes a first recess portion 2221 and a support protrusion portion 2222. The first recess portion 2221 is recessed from a side surface of the first segment 222 in a direction perpendicular to a central axis of the first segment 222. The support protrusion portion 2222 protrudes from a surface of the first recess portion 2221. The support protrusion portion 2222 may be in approximately a plate shape. A thickness of the support protrusion portion 2222 may be smaller than a width of the holding groove 3113, such that the support protrusion portion 2222 can be inserted into the holding groove 3113 and clamped between the two ear portions 3114. The rotating portion 311 is rotatably coupled to the first segment 222 through a rotating shaft 3115 of the support protrusion portion 2222 and the ear portions 3114.

A set screw 313 is disposed on the rotating portion 311, and the set screw 313 passes through the rotating portion 311 and matches with the rotating shaft 3115, to prevent movement of the rotating shaft 3115 in an axial direction thereof.

An elastic member (not shown) may be arranged between the rotating portion 311 and the first segment 222 to cause the rotating portion 311 to have an automatic reset function. In some embodiments, when the first connecting member 31 is not coupled to the second connecting member 32, the elastic member can maintain the rotating portion 311 at a position approximately perpendicular to the first segment 222.

In some embodiments, the elastic member may include a torsion spring, and may cover the rotating shaft 3115 as a sleeve. One end elastic leg may abut against the rotating portion 311, and the other end elastic leg may abut against the first segment 222.

The rotating portion 311 and the first segment 222 may be rotatably coupled to each other by other structures, which are not limited to the above-described structures.

In some embodiments, the first engaging member 312 is partially arranged in the rotating portion 311 and rotatably coupled to the rotating portion 311. In some embodiments, a recess groove 3116 is arranged at a matching surface 3111 of the rotating portion 311, and the first engaging member 312 is arranged in in the recess groove 3116. In some embodiments, the first engaging member 312 is rotatably coupled to the rotating portion 311 through a rotating shaft 3117.

A set screw 314 is arranged at the rotating portion 311. The set screw 314 passes through the rotating portion 311 and matches with the rotating shaft 3117 to prevent a movement of the rotating shaft 3117 in an axial direction thereof.

In some embodiments, the first engaging member 312 includes a sheet-shaped engaging member. The sheet-shaped engaging member includes an engaging end 3121 and a driving end 3122 opposite to the engaging end 3121. The rotating shaft 3117 is coupled to the first engaging member 312 and between the engaging end 3121 and the driving end 3122 of the first engaging member 312. In some embodiments, the first engaging member 312 and the rotating shaft 3117 form a lever structure, and a pivot point of the lever structure is arranged at the rotating shaft 3117. The engaging end 3121 may face toward the first segment 222, and the driving end 3122 may face away from the first segment 222. The engaging end 3121 can swing with a rotation of the first engaging member 312. In some embodiments, the engaging end 3121 can protrude outside the recess groove 3116.

The first engaging member 312 may be maintained at a certain angle with respect to the rotating portion 311 through an elastic member (not shown). When the first connecting member 31 and the second connecting member 32 are not coupled to each other, the elastic member may maintain the first engaging member 312, such that the engaging end 3121 may protrude from the recess groove 3116 at an angle. When an external force applied to the first engaging member 312 overcomes the elastic force of the elastic member, the first engaging member can rotate relative to the rotating portion 311. However, the elastic member may accumulate elastic potential energy, and the elastic potential energy can cause the first engaging member 312 to tend to return to the original status once the external force disappears.

In some embodiments, the elastic member may include a torsion spring that covers the rotating shaft 3117 as a sleeve. One end elastic leg may abut against the rotating portion 311, and the other end elastic leg may abut against the first engaging member 312.

The first engaging member 312 and the rotating portion 311 may be rotatably coupled to each other by other structures, which are not limited to the above-described structures.

In some embodiments, the second connecting member 32 may include a second engaging member 321 and an unlocking portion 322. The second engaging member 321 can engage with the first engaging member 312. The unlocking portion 322 can release the engagement coupling between the first engaging member 312 and the second engaging member 321, i.e., release the locking between the first segment 222 and the second segment 223.

The second engaging member 321 and the unlocking portion 322 both may be arranged on the second segment 223. In some embodiments, a second recess portion 223a is arranged at the second segment 223. The second recess portion 223a is recessed from an outer peripheral surface of the second segment 223 in a direction perpendicular to a central axis of the second segment 223. The second recess portion 223a forms a bottom surface 2231 and a side surface 2232 at the second segment 223. The second engaging member 321 is formed by protruding from the bottom surface 2231. The unlocking portion 322 is arranged in the second segment 223, and a part of the unlocking portion 322 protrudes from the side surface 2232. In some embodiments, a length of the second recess portion 223a may be approximately equal to a length of the rotating portion 311.

In some embodiments, the second engaging member 321 has an approximately V shape, and includes an engaging recess 3211, a stopping portion 3212, and a guiding portion 3213. The guiding portion 3213 may be coupled to the stopping portion 3212 at a preset angle. The engaging recess 3211 is formed between the stopping portion 3212 and the guiding portion 3213. The engaging recess 3211 can accommodate and engage with the engaging end 3121 of the first engaging member 312. The stopping portion 3212 can stop the engaging end 3121 of the first engaging member 312. The guiding portion 3213 may be used for guiding a travel of the engaging end 3121 of the first engaging member 312, such that the engaging end 3121 may engage with the engaging recess 3211. The guiding portion 3213 includes a guiding surface 3213a. The guiding surface 3213a may be tilted with respect to the bottom surface 2231. A tilt angle of the guiding surface 3213a relative to the bottom surface 2231 can be chosen according to a certain degree of freedom, as long as the engaging end 3121 of the first engaging member 312 can be guided to engage with the engaging recess 3211. For example, the angle can be 5 degrees, 6 degrees, 8 degrees, 10 degrees, 15 degrees, 20 degrees, 30 degrees, 45 degrees, 60 degrees, etc.

The unlocking portion 322 may be rotatably coupled to the second segment 223. The unlocking portion 322 includes a supporting portion 3221, a pressing portion 3222, and a driving portion 3223. The supporting portion 3221 is arranged between the pressing portion 3222 and the driving portion 3223. The pressing portion 3222 and the driving portion 3223 are coupled to two sides of the support portion 3221.

The unlocking portion 322 is partially accommodated in the second segment 223 and partially protrude from the second segment 223. In some embodiments, an accommodating groove may be arranged at the second segment 223. The accommodating groove 2233 may extend through the outer peripheral surface and the side surface 2232 of the second segment 223. The pressing portion 3222 may be arranged in the accommodating groove 2233. The supporting portion 3221 may be rotatably coupled to the second segment 223, and the driving portion 3223 may protrude from the side surface 2232.

The above-described unlocking portion 322 may include a lever structure. When the pressing portion 3222 is pressed, the driving portion 3223 can be tilted up to drive the driving end 3122 of the first engaging member 312 to move.

In some embodiments, the unlocking portion 322 may include an elastic member (not shown) for resetting the unlocking portion 322. In some embodiments, the elastic member may include a torsion spring, and one end elastic leg may abut against the second segment 223, and the other end elastic leg may abut against the unlocking portion 322.

The power assembly 40 may be used for providing the UAV 100 with flight power. The power assembly 40 may be arranged at the installation member 221. The power assembly 40 may include a motor 41 and a propeller (not shown) coupled to the motor 41. The motor 41 can drive the propeller to rotate, thereby generating power to drive the UAV 100 to move. The motor 41 may include any suitable type of motor such as a brushless motor or a brushed motor. The motor 41 can be electrically coupled to electronic components, such as a flight controller, a power source, etc., of the fuselage 10 to drive the propeller to rotate according to preset rotation speed and direction. The motor 41 may be fixed to corresponding installation member 221, and can be electrically coupled to the electronic components of the fuselage 10 through conductive wires (not shown) arranged in the arm 20. The propeller may be coupled to a rotating shaft of the motor 41 and can rotate together with a rotation of the rotating shaft. In some embodiments, the propeller may be a foldable propeller, and when the UAV 100 is not flying, the propeller may be folded to reduce a volume of the UAV 100 for storage and transportation.

The UAV 100 may further include a stand 50 for use as a support for landing of the UAV 100. In some embodiments, the number of the stands 50 may be four, and the stands 50 may be arranged at ends of the branch-arms 22. The stands 50 may also be arranged at other positions of the UAV 100. The number of the stands 50 can also be changed according to various application scenarios. For example, the stands 50 can also include two U-shaped bracket structures coupled to the fuselage 10.

To lock, the second segment 223 may be rotated approximately to a coaxial position relative to the first segment 222, and the rotating portion 311 may be rotated toward the second segment 223. During the rotation of the rotating portion 311, the engaging end 3121 of the first engaging member 312 may engage with the engaging recess 3211 along the guiding portion 3213. As the rotating portion 311 is rotated to the matching surface 3111 and matches with the bottom surface 2231, the engaging end 3121 may entirely engage with the engaging recess 3211, and the first engaging member 312 and the second engaging member 321 may engage with each other at a dead point position, and the first segment 222 and the second segment 223 may be locked. Correspondingly, the driving end 3122 of the first engaging member 312 may be close to the driving portion 3223 of the unlocking portion 322.

To unlock, the pressing portion 3222 may be pressed to cause the driving portion 3223 to tilt up, and hence to drive the driving end 3122 of the first engaging member 312 to move. Correspondingly, the engaging end 3121 may disengage from the engaging recess 3211 to move and pass over an engagement dead point position, and the engagement of the first engagement portion 312 and the second engagement portion 321 may be released. That is, locking between the first segment 222 and the second segment 223 may be released. Accordingly, the second segment 223 can be rotated relative to the first segment 222 to realize folding and gathering of the UAV 100.

In the UAV 100, the arm 20 may be divided into a plurality of portions that can be rotatably coupled by using the connecting assembly 30, such that the folding of the arm 20 of the UAV 100 can be realized, facilitating the storage, carrying and transport of the UAV.

Structures of the first connecting member 31 and the second connecting member 32 can be interchanged. That is, the structure of the first connecting member 31 can be arranged at the second segment 223, the structure of the second connecting member 32 can be arranged at the first segment 222.

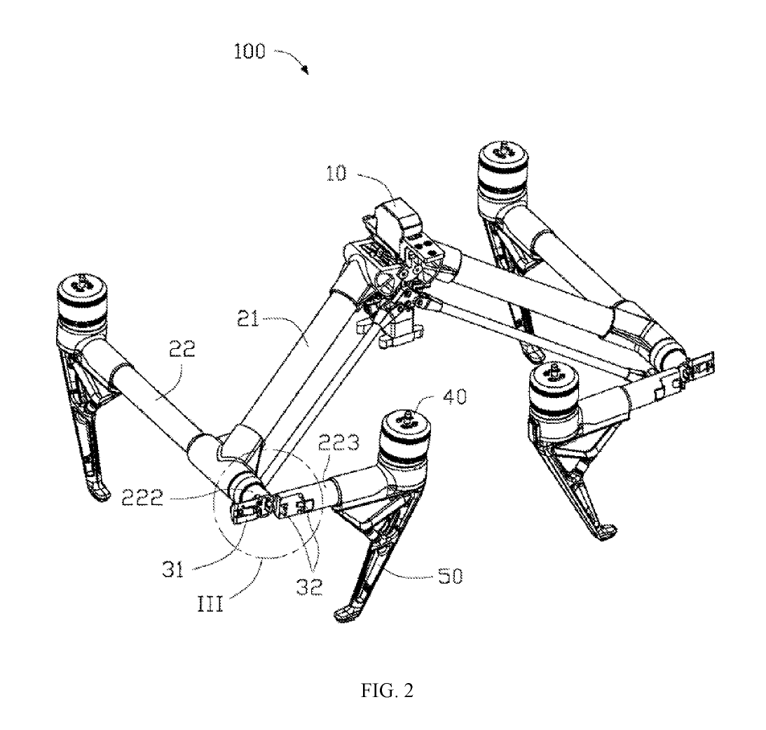

In some embodiments, as shown in figures such as FIGS. 1 and 2, a connecting assembly 30 is arranged on two branch-arms 22. The number of the connecting assemblies 30 may vary according to various application scenarios. For example, each branch-arm 22 may be provided with a connecting assembly 30.

In some embodiments, the first segment 222 and the second segment 223 may be rotatably coupled to each other. In some embodiments, the first segment 222 and the second segment 223 may be detachably coupled to each other. After being unlocked, the second segment 223 can be detached from the UAV 100 for separate storage and keeping.

In some embodiments, the connecting assembly 30 may be arranged at the main arm 21, such that the main arm 21 can be folded and the UAV 100 can be further folded for a smaller folded volume.

Other embodiments of the disclosure will be apparent to those skilled in the art from consideration of the specification and practice of the embodiments disclosed herein. It is intended that the specification and examples be considered as exemplary only and not to limit the scope of the disclosure, with a true scope and spirit of the invention being indicated by the following claims.

What is claimed is:

1. An unmanned aerial vehicle (UAV) comprising:
a fuselage; and
an arm coupled to the fuselage and comprising a first segment, a second segment, and a connecting assembly coupling and locking the first segment and the second segment to each other, the connecting assembly comprising:
a first connecting member rotatably coupled to one of the first segment or the second segment; and
a second connecting member coupled to another one of the first segment or the second segment,
wherein the first connecting member is rotatable relative to the arm and engages with the second connecting member to lock the first segment and the second segment.

2. The UAV according to claim 1, wherein:
the first connecting member comprises a rotating portion and a first engaging member,
the second connecting member comprises a second engaging member, and
the first connecting member engages with the second connecting member through matching between the first engaging member and the second engaging member.

3. The UAV according to claim 2, wherein:
the rotating portion comprises a matching surface and a side surface,
the matching surface comprises a groove, and
the first engaging member is rotatably accommodated in the groove.

4. The UAV according to claim 2, wherein the first engaging member is rotatably coupled to the rotating portion through a rotating shaft.

5. The UAV according to claim 4, further comprising:
a set screw passing through the rotating portion and matching with the rotating shaft to prevent movement of the rotating shaft in an axial direction.

6. The UAV according to claim 4, further comprising:
an elastic member arranged between the first engaging member and the rotating portion,
wherein the elastic member is configured to cause the first engaging member to maintain a preset angle with respect to the rotating portion.

7. The UAV according to claim 6, wherein the elastic member comprises a torsion spring comprising one end elastic leg that abuts against the rotating portion and another end elastic leg that abuts against the first engaging member.

8. The UAV according to claim 4, wherein:
the first engaging member comprises an engaging end and a driving end opposite to the engaging end,
the engaging end engages with the second engaging member, and
the driving end is configured to be driven to disengage the engaging end from the second engaging member.

9. The UAV according to claim 8, wherein:
the engaging end and the driving end are arranged on two sides of the rotating shaft, respectively, and
the driving end is configured to move in a first direction opposite to a second direction in which the engaging end moves when the engaging end is driven to move.

10. The UAV according to claim 9, wherein:
the second engaging member comprises an engaging recess, and
the engaging recess is configured to engage with the engaging end to lock the first segment and the second segment.

11. The UAV according to claim 10, wherein:
the second engaging member further comprises a stopping portion, and
the stopping portion is configured to stop the engaging end when the engaging end engages with the engaging recess.

12. The UAV according to claim 11, wherein the second engaging member further comprises a guiding portion configured to guide travel of the engaging end to cause the engaging end to engage with the engaging recess.

13. The UAV according to claim 12, wherein:
the guiding portion is coupled to the stopping portion at a preset angle, and
the engaging recess is arranged between the guiding portion and the stopping portion.

14. The UAV according to claim 12, wherein:
the guiding portion comprises a guiding surface,
the guiding surface comprises a slope, and
the engaging end is configured to move along the guiding surface to engage with the engaging recess.

15. The UAV according to claim 2, wherein:
the second connecting member comprises an unlocking portion, and
the unlocking portion is configured to unlock an engagement between the first engaging member and the second engaging member to release the first segment from the second segment.

16. The UAV according to claim 15, wherein:
the second segment comprises a recess portion recessed from an outer peripheral surface of the second segment in a direction perpendicular to a central axis of the second segment,
the recess portion forms a bottom surface and a side surface at the second segment,
the second engaging member protrudes from the bottom surface, and
the unlocking portion is arranged at the second segment, and a part of the unlocking portion protrudes from the side surface.

17. The UAV according to claim 16, wherein:
the unlocking portion comprises a supporting portion, a pressing portion, and a driving portion,
the supporting portion is arranged between the pressing portion and the driving portion,
the pressing portion and the driving portion are coupled to two sides of the supporting portion, respectively, and
the driving portion is configured to drive the first engaging member to move to release the first segment from the second segment.

18. The UAV according to claim 17, wherein:
the second segment comprises an accommodating groove extending through the outer peripheral surface and the side surface of the second segment,
the pressing portion is arranged in the accommodating groove,
the supporting portion is rotatably coupled to the second segment, and
the driving portion protrudes from the side surface.

19. The UAV according to claim 15, wherein the unlocking portion further comprises an elastic member elastically arranged between the second segment and the unlocking portion and configured to reset the unlocking portion.

20. The UAV according to claim 19, wherein the elastic member comprises a torsion spring comprising one end elastic leg that abuts against the second segment and another end elastic leg that abuts against the unlocking portion.

21. The UAV according to claim 1, wherein:
the first segment is rotatably coupled to the second segment, and
the connecting assembly is configured to lock the first segment in an approximately coaxial position relative to the second segment.

22. The UAV according to claim 21, wherein:
the first segment and the second segment are rotatably coupled to each other through the rotating shaft, and
the arm further comprises a set screw that matches with the rotating shaft to prevent the rotating shaft from moving relative to the first segment and the second segment in a direction of central axis of the rotating shaft.

23. The UAV according to claim 1, wherein:
the first segment comprises a recess portion and a support protrusion portion,
a holding groove is arranged at an end of the first connecting member that is coupled to the first segment, and
the supporting protrusion portion is inserted in the holding groove and is rotatably coupled to the first connecting member.
